(19) United States
(12) Patent Application Publication
(10) Pub. No.: US 2014/0048993 A1
(43) Pub. Date: Feb. 20, 2014

(54) SELECTIVE PLACEMENT OF COOLANT TO UNDERCUT AREAS

(71) Applicant: Piotr S. TRZASKOS, Saratoga, CA (US)

(72) Inventor: Piotr S. TRZASKOS, Saratoga, CA (US)

(73) Assignee: Apple Inc., Cupertino, CA (US)

(21) Appl. No.: 13/588,263

(22) Filed: Aug. 17, 2012

(51) Int. Cl. B23Q 3/00

(52) U.S. Cl. 269/20

(57) ABSTRACT

The described embodiment relates generally to the use of a specialized workpiece fixture to keep a workpiece surface covered with cutting fluid during a machining operation. More specifically the specialized workpiece fixture allows a downward facing undercut area to remain covered with coolant by utilizing nozzles arranged underneath the undercut area for coolant delivery.

### BACKGROUND

1. Technical Field

The described embodiment relates to the use of a specialized workpiece fixture to keep a workpiece surface covered with cutting fluid during a machining operation.

2. Related Art

In some cases heat generated during light machining of a workpiece can be sufficiently dissipated by convection to surrounding ambient air and by removal of heated small chips of the workpiece during the machining process. In operations where the aforementioned heat dissipation is insufficient to remove the heat generated during a machining operation a cutting fluid is typically applied to help cool and lubricate both the cutting tool and the workpiece being machined. Commonly used cutting fluids include petroleum distillates, animal fats, plant oils, and water. In addition to helping to cool the workpiece and cutting tool, cutting fluid is also useful for maximizing tool life. Since it can keep a working surface of the cutting tool well lubricated tip welding can be significantly reduced. Furthermore, use of cutting fluid can prevent rust on machine parts and cutters. Cutting fluid is commonly applied from above or laterally during a cutting operation. Unfortunately, in machining operations in which a downward facing undercut area is being machined a volume of cutting fluid actually reaching the undercut area can be insufficient when the cutting fluid is not being applied directly to the undercut area. This problem is only aggravated by gravity tending to pull the fluid from the cutting surface.

Therefore, what is desired is a way to keep a downward facing cutting surface well covered with cutting fluid during a machining operation.

### SUMMARY OF THE DESCRIBED EMBODIMENTS

This paper describes many embodiments that relate to an apparatus, and method for enabling reliable, robust, and cost effective means for applying cutting fluid to an undercut area of a workpiece.

In one embodiment a machining apparatus is disclosed. The machining apparatus includes a workpiece attachment component configured to secure a workpiece during a machining operation. The workpiece attachment component includes at least the following: (1) an intake configured to receive a continuous flow of cutting fluid, and (2) a number of nozzles each of which receives a corresponding portion of the continuous flow of cutting fluid, the plurality of nozzles configured to provide the cutting fluid to an undercut area of the workpiece otherwise obscured by a cutting tool in order to remove excess heat and provide additional lubrication during the machining operation. During the machining operation, only a subset of the plurality of nozzles corresponding to a current position of the cutting tool provides the cutting fluid to that portion of the workpiece undergoing the machining operation.

In another embodiment a machining apparatus is disclosed. The machining apparatus includes a fixture configured to secure a workpiece by vacuum suction during a machining operation. The fixture includes at least the following: (1) a fluid intake configured to receive a continuous flow of cutting fluid; (2) a number of nozzles each of which receives a corresponding portion of the continuous flow of cutting fluid, the plurality of nozzles configured to provide the cutting fluid to an undercut area of the workpiece otherwise obscured by a cutting tool in order to remove excess heat and provide additional lubrication during the machining operation; (3) a manifold having a number of connecting channels configured to route cutting fluid from the fluid intake to the nozzles; and (4) a number of sensors configured to remotely detect operating conditions during the machining operation. During the machining operation, only a subset of the plurality of nozzles corresponding to a current position of the cutting tool provides the cutting fluid to that portion of the workpiece undergoing the machining operation.

In yet another embodiment a machining method is disclosed. The method includes at least the following steps: (1) securing a workpiece to a fixture having a number of integrated nozzles oriented towards an undercut area of the workpiece; (2) receiving cutting fluid through an intake on the fixture; (3) initiating a machining operation with a cutting tool after channels inside the fixture have been pressurized by the received cutting fluid to a minimum threshold level; (4) providing cutting fluid to an undercut area of the workpiece by only a selected subset of the plurality of nozzles; and (5) periodically updating the selected subset of the integrated nozzles so that only portions of the undercut area of the workpiece in close proximity to the machining operation are supplied with cutting fluid.

### BRIEF DESCRIPTION OF THE DRAWINGS

These drawings in no way limit any changes in form and detail that may be made to the described embodiments by one skilled in the art without departing from the spirit and scope of the described embodiments. The described embodiments and the advantages thereof may be readily understood by reference to the following description taken in conjunction with the accompanying drawings, wherein like reference numerals designate like structural elements, and in which:

FIG. 1 shows a perspective view of a workpiece mounted to a fixture undergoing a machining process by cutting tool;

FIG. 2 shows a perspective view of one embodiment of a cutting fluid delivery system designed to fit inside the fixture described in FIG. 1;

FIG. 3A shows a cross-sectional side view of the fixture described in conjunction with FIG. 1 along with the workpiece and the cutting tool also described in FIG. 1;

FIG. 3B shows an alternative cross-sectional side view in which an orientation of a cutting fluid delivery nozzle is altered to more effectively hit a bottom surface of the workpiece; and

FIG. 4 shows a flowchart detailing a process for machining a workpiece in accordance with the described embodiments.

### DETAILED DESCRIPTION OF EXAMPLE EMBODIMENTS

A representative apparatus and application of methods according to the present application are described in this section. These examples are being provided solely to add context and aid in the understanding of the described embodiments. It will thus be apparent to one skilled in the art that the described embodiments may be practiced without some or all of these specific details. In other instances, well known process steps have not been described in detail in order to avoid unnecessarily obscuring the described embodiments. Other applications are possible, such that the following examples should not be taken as limiting.

In the following detailed description, references are made to the accompanying drawings, which form a part of the description and in which are shown, by way of illustration, specific embodiments in accordance with the described embodiments. Although these embodiments are described in sufficient detail to enable one skilled in the art to practice the described embodiments, it is understood that these examples are not limiting; such that other embodiments may be used, and changes may be made without departing from the spirit and scope of the described embodiments.

Cutting fluid can act as both a lubricant and a coolant in cutting operations. In its lubricant capacity the cutting fluid can prolong cutting tool life and in many cases suppress the spread of airborne dust as small particles of material are removed from a surface of a workpiece. In its coolant capacity the cutting fluid allows heat from the both the cutting tool and the workpiece to be conductively dissipated from the working surface. In some embodiments a nozzle or series of nozzles can be configured to deliver cool cutting fluid continuously across machining surfaces, thereby providing a continuous means of efficiently removing heat during a machining operation. In this way the cutting fluid can be utilized to control the operating temperature of both the workpiece and the cutting tool during the machining operation. In certain scenarios the fluid application can allow machining operations to take place more quickly than would otherwise be possible, especially when such operations are otherwise prevented by excess heat build up. A problem addressed in this application is how to continuously coat the surface of downward facing, undercut area of a workpiece surface. In addition to gravity influencing cutting fluid to drip or bead off the undercut area, spinning machining tools further exacerbated cutting fluid removal rates. When machining tools spin at high speeds during a cutting operation they tend to vacate the working surface of cutting fluid. Spinning machining tools also tend to be larger and tend to block direct application of cutting fluid to the undercut area. Consequently, a robust means of continuously applying the cutting fluid directly to the cutting surface is important to success.

In one embodiment cutting fluid delivery nozzles can be embedded into the fixture itself. By positioning the nozzles in the fixture directly below the working surface, cutting fluid can be generously applied since this nozzle configuration allows cutting fluid to be applied directly between the undercut area and the cutting tool with minimal interference from the cutting tool. Since a cutting operation is generally applied across a long cutting path the nozzles can be periodically placed along the path of the cutting tool, which also tends to coincide with the outer shape of the fixture. In this embodiment all of the cutting fluid delivery nozzles can be continuously activated throughout the machining process. Continuous activation may be more desirable in certain scenarios in which only a short cutting path is contemplated, or where increased fixture design complexity is undesirable. Cutting fluid delivery nozzles can be activated by attaching a pressurized flow of cutting fluid to the fixture.

In another embodiment also having embedded cutting fluid delivery nozzles, cutting fluid delivery nozzles are only selectively activated. At least two or three nozzles can be selected for activation at any given time, resulting in application of cutting fluid in front of, along with, and behind the cutting tool. Determination of which nozzles should be active at any given time can be accomplished in a number of different ways. When the cutting process and time to machine the workpiece are well known a timer can be used to activate the nozzles as the cutting tool traverses the surface of the workpiece. In other scenarios in which cutting times are more variable any communication channel between the cutting tool and the fixture can be used to communicate position information to the fixture. By relaying position information from the cutting tool to the fixture, a controller associated with the fixture can determine which nozzles to leave open. Determination of the position of the cutting tool can also be derived from sensors built into the fixture itself. In this way no link is required between the cutting tool and the fixture, thereby allowing the fixture to independently determine which nozzles to select. This advantageously allows use of a more generic cutting tool that need not be specially customized to interface with the fixture.

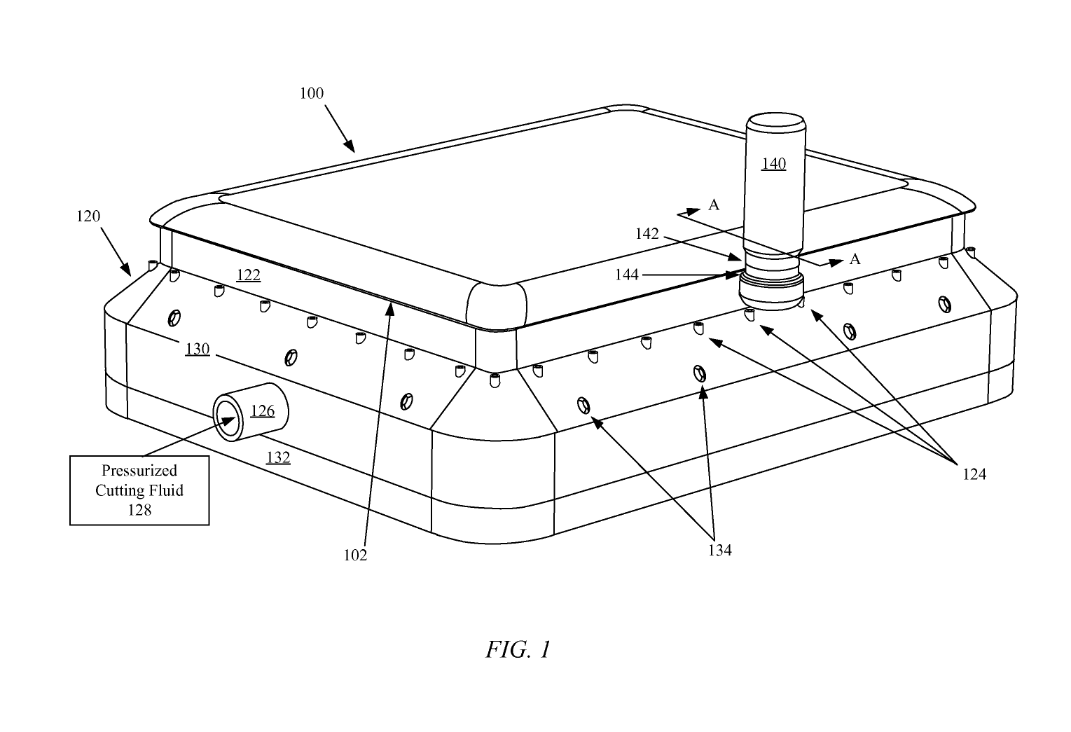

These and other embodiments are discussed below with reference to FIGS. 1-4; however, those skilled in the art will readily appreciate that the detailed description given herein with respect to these figures is for explanatory purposes only and should not be construed as limiting.

FIG. 1 shows a perspective view of workpiece 100 mounted to fixture 120, while being machined by cutting tool 140. Workpiece 100 can be any workpiece requiring machining along an undercut area. In this figure workpiece 100 is embodied by an enclosure for an iPad, manufactured by Apple, Inc. of Cupertino, Calif. Workpiece 100 is held in place by vacuum attachment component 122. Vacuum attachment component 122 is integrated into fixture 120 and can hold workpiece 100 firmly in place during a machining operation. Vacuum attachment component can be powered by one or more vacuum ports to generate sufficient suction to hold workpiece 100 securely in place. In this embodiment workpiece 100 requires an undercut area 102 to be rounded or chamfered by cutting tool 140. Undercut area 102 extends around an entire periphery of workpiece 100. A vertically oriented cutting tool 140 is depicted in FIG. 1; however, it should be noted that in some cases it may be desirable to orient the cutting tool horizontally. Cutting tool 140 includes recessed region 142 which allows cutting tool 140 to machine a bottom surface of workpiece 100 without coming into direct contact with a lateral edge of workpiece 100 first. This allows cutting surface 144 to come into contact with undercut area 102 of workpiece 100 during a machining operation. Regardless of orientation, cutting tool 140 tends to obscure undercut area 102 from externally mounted fluid delivery mechanisms.

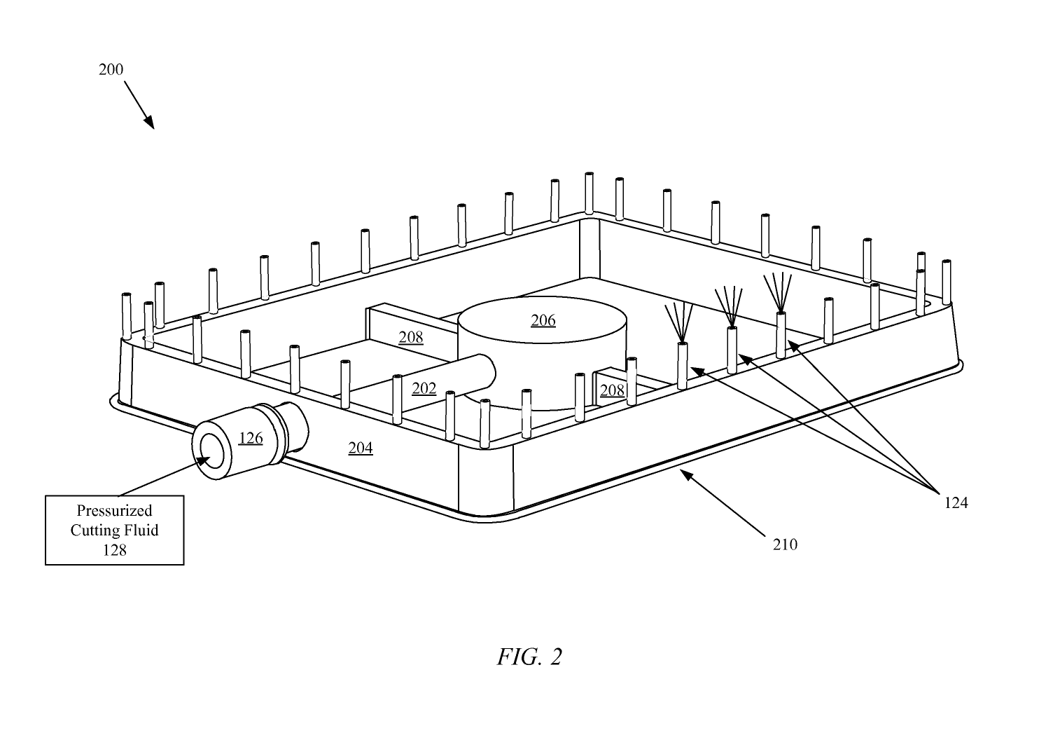

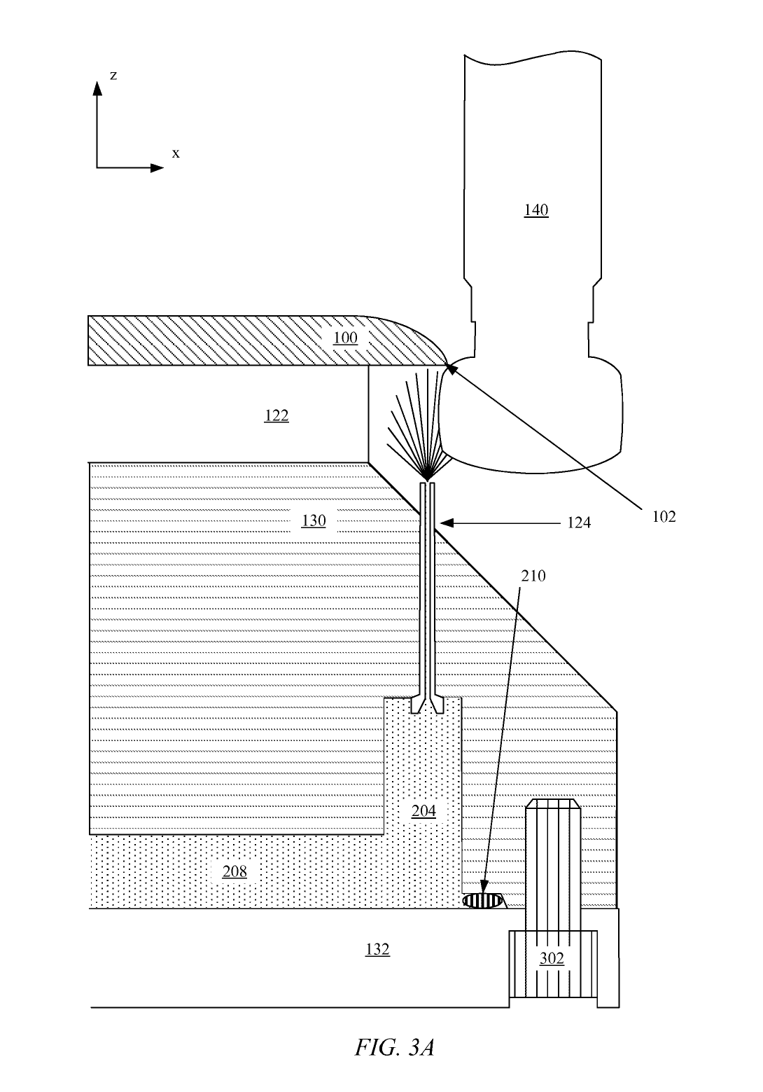

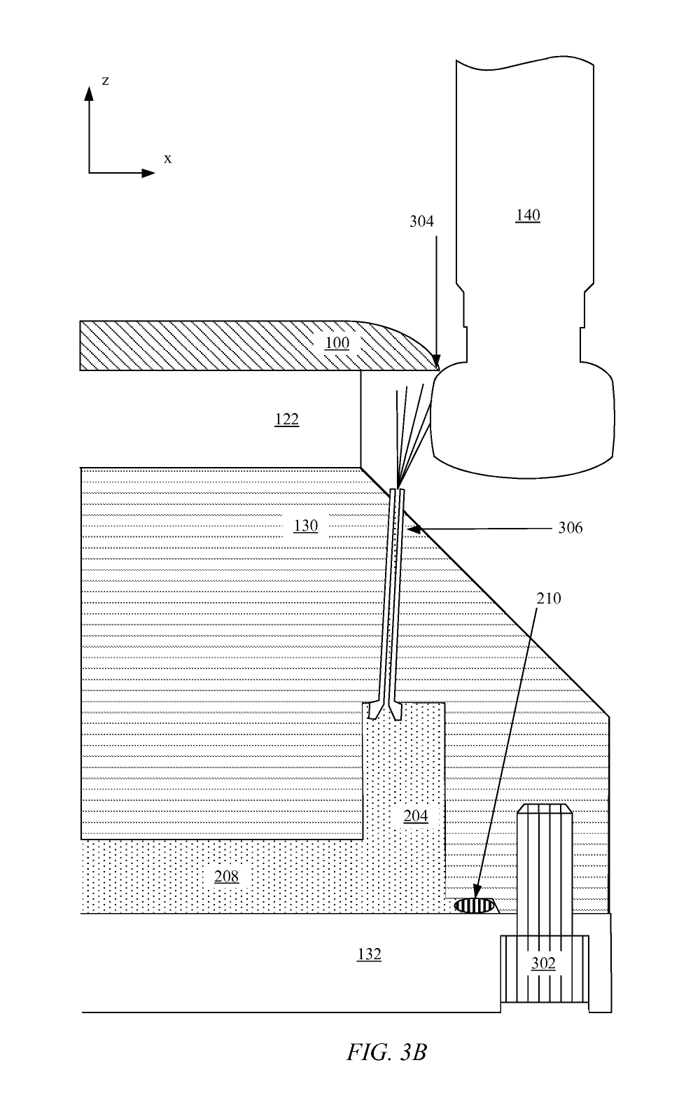

Cutting fluid delivery nozzles 124 can be supplied with cutting fluid during the machining operation through cutting fluid intake 126. Pressurized cutting fluid 128 can include any appropriate cutting fluid such as petroleum distillates, animal fats, plant oils, or even water. Pressurized cutting fluid 128 is channeled through cutting fluid reservoir component 130 of fixture 120 which allows cutting fluid to be efficiently distributed to cutting fluid delivery nozzles 124 through channels in cutting fluid reservoir component 130. One preferred method of distribution is described in detail below in FIG. 2. Once cutting fluid 128 is delivered to cutting fluid delivery nozzles 124 cutting tool 140 can then be used to make a precision cut along undercut area 102 of workpiece 100. In some embodiments the precision cut can be clean enough so as not to require further finishing operations. Cutting fluid reservoir component 130 can be securely attached to baseplate 132 by way of a series of fasteners (not shown), which can be inserted through a bottom surface of baseplate 132 (illustrated in FIGS. 3A and 3B below).

In one embodiment sensors 134 can be integrated into fixture 120. Sensor 134 can be used to determine a current location of cutting tool 140. A subset of cutting fluid delivery nozzles 124 can be selected in accordance with the current location of cutting tool 140. In addition to selecting a subset of nozzles flow rate can also be modulated in accordance with information gathered by sensors 134. Sensors 134 can be infrared heat sensing sensors. By monitoring the amount of heat being emitted from workpiece 100, an appropriate flow rate increase can be determined for portions of workpiece 100 most in need of cooling. In a machining operation, sufficient heat can be generated in front of and behind workpiece 100 sufficient to allow sensors 134 to detect generated heat and direct nearby cutting fluid delivery nozzles 124 to target portions of workpiece 100 in close proximity to cutting tool 140. This can be especially useful when temperatures rise unexpectedly. Upon detecting such a phenomenon, input from sensors 134 can be used to generate a control signal directing increased flow rate from cutting fluid delivery nozzles 124, thereby preventing undesirable overheating of workpiece 100 or cutting tool 140. Increased flow rate can be obtained in many ways, by for example, reducing the selected subset of active cutting fluid delivery nozzles or by sending a control signal directing an increase in pressure of pressurized cutting fluid 128.

In another embodiment sensors 134 can also be motion sensors useful for selecting a new subset of cutting fluid delivery nozzles 124 when motion of cutting tool 140 enters a field of view of a corresponding to a motion sensor 134. In some embodiments only one motion sensor can be necessary on any given side of fixture 120, while in other embodiments where more precision is desired a sensor 134 can be associated with each of cutting fluid delivery nozzles 124. In a well monitored configuration cutting fluid delivery nozzle 124 selection can be highly accurate allowing for increased flow rate and pressure due to narrow selection of appropriate cutting fluid delivery nozzles 124. In the depicted embodiment each of sensors 134 covers between two and four cutting fluid delivery nozzles. The depicted configuration of motion sensors can be used to accurately track the speed of cutting tool 140. When changes in speed are detected flow rate of cutting fluid 128 through cutting fluid delivery nozzles 124 can be adjusted accordingly. Furthermore, accurate determination of velocity of the cutting tool can also help anticipate changes in the selected subset of cutting fluid delivery nozzles 124, allowing sufficient time for a new set of nozzles to be selected and activated. Finally, in yet another embodiment a combination of both motion and thermal sensors can be utilized. Such a configuration would allow the fixture to receive the benefits associated with both types of sensors.

FIG. 2 shows a perspective view of one embodiment of cutting fluid delivery system 200, separated from the rest of fixture 120. In this embodiment cutting fluid delivery system 200 can be entirely contained within cutting fluid reservoir component 130. Cutting fluid delivery system 200 includes cutting fluid intake 126 and cutting fluid delivery nozzles 124 that operate as described in relation to FIG. 1. As cutting fluid 128 is delivered to cutting fluid delivery system 200, through cutting fluid intake 126 it travels along intake tube 202. Intake tube 202 traverses through delivery channel 204. In this embodiment intake tube 202 passes through a hole built into delivery channel 204. In other configurations intake tube 202 can be built into delivery channel 204. The walls of intake tube 202 essentially form a barrier between cutting fluid flow in intake pipe 202 and flow in delivery channel 204. After intake tube 202 passes through delivery channel 204 it then transfers cutting fluid 128 into manifold 206. By allowing a large volume of cutting fluid to be pressurized inside fixture 120 fluctuations in the delivery pressure of cutting fluid 128 can be dampened; moreover, any unexpected losses in delivery pressure can be mitigated since the volume of pressurized fluid can in some cases keep cutting fluid flowing long enough to allow a cutting operation sufficient time to shut down after an unexpected pressure loss. In this way potential damage to the workpiece from a lack of lubrication and high heat during a machining operation can be avoided.

After entering manifold 206 cutting fluid flows through connecting channels 208. Connecting channels 208 facilitate the transfer of cutting fluid from manifold 206 to delivery channel 204. While only two branches are shown in the depicted embodiment many more branches are certainly within the scope of the described embodiments. Multiple connecting channels 208 help keep pressure balanced across the length of delivery channel 204. This is especially critical in configurations where only certain nozzles are being utilized. In some situations a nearby connecting channel 208 can help keep active nozzles continuously pressurized more effectively than a connecting channel 208 located farther down delivery channel 204. After cutting fluid 128 fills delivery channel 204 further pressurization of fluid delivery system 200 allows high speed delivery of cutting fluid 128 from cutting fluid delivery nozzles 124. In some embodiments cutting fluid delivery nozzles 124 can include a built in valve such as a ball valve for preventing cutting fluid 128 from escaping cutting fluid delivery nozzles 124 until a minimum pressure is established. In other embodiments cutting fluid delivery nozzles can include an electronic valve which can be opened whenever cutting fluid is required. Cutting fluid delivery system 200 is useful for supplying cutting fluid in a rectangular pattern (circular and other irregularly shaped configurations are also within the contemplated scope of the described embodiment); however, when a single cutting tool is being used to accomplish the machining operation the entire surface may not need to be continuously covered with cutting fluid. Configurations having electronic nozzle controls can conserve cutting fluid and increase delivery pressure by expelling cutting fluid only where needed. In FIG. 2, three cutting fluid delivery nozzles 124 are shown releasing cutting fluid. By limiting the number of active cutting fluid delivery nozzles 124, cutting fluid can be released at higher speed, resulting in better cooling and lubrication of the machining surface for any given pressurization of cutting fluid delivery system 200.

In addition to regulating flow of cutting fluid 128 at cutting fluid delivery nozzles 124 the flow can be limited at an earlier stage in cutting fluid delivery system 200. In one embodiment delivery channel 204 can be partitioned so that a number of independent zones can be established in cutting fluid delivery system 200. Each zone can be fed by one connecting channel 208. While FIG. 2 only depicts two connecting channels 208, a number of connecting channels 208 can be established. In one embodiment a single connecting channel 208 can feed 2-3 cutting fluid delivery nozzles 124. By placing a valve at one point along each of connecting channels 208 pressurized cutting fluid 128 can be limited to one or two connecting channels 208, thereby limiting cutting fluid delivery only to portions of workpiece 100 being actively machined. In another embodiment each individual cutting fluid delivery nozzle can be configured with a ball valve to prevent cutting fluid 128 flowing out when its associated zone is not activated.

Another useful feature of this embodiment of cutting fluid delivery system 200 is that it remains unsealed until fully attached to baseplate 132. Since cutting fluid delivery system 200 is housed completely inside cutting fluid reservoir component 130 cutting fluid channels can be sealed once cutting fluid reservoir component 130 is securely fastened to baseplate 132. Once fluid reservoir component 130 is fastened to baseplate 132 O-ring 210 allows a tight seal to be formed between the two components, thereby allowing fluid delivery system 200 to be pressurized. This configuration also allows for cutting fluid to be easily purged from fluid delivery system 200. Once fluid reservoir component 130 is separated from baseplate 132, cutting fluid 128 can easily flow out of fluid delivery system 200, enabling easy fluid draining and convenient, thorough cleaning.

FIG. 3A shows a cross-sectional side view of fixture 120, workpiece 100 and cutting tool 140 as defined in FIG. 1 by cross-section A-A. In this embodiment the attachment method between fluid reservoir component 130 and baseplate 132 can be clearly seen. Fastener 302 can be driven through a bottom surface of baseplate 302 and up into fluid reservoir component 130 to securely fasten the two components together. To create an even seal across O-ring 210 a number of fasteners 302 can be used along a peripheral portion of fixture 120. In most cases fastener 302 will be outbound of O-ring 210 and delivery channel 204 to create a robust seal that can be properly pressurized during machining operations. Also depicted in FIG. 3A is cutting fluid delivery nozzle 124. As depicted cutting fluid delivery nozzle 124 is hollow and in this embodiment all nozzles would spray cutting fluid simultaneously, continuously covering the entire machining path along undercut area 102. The addition of a ball valve to nozzle 124 allows pressure to build up in delivery channel 204 until cutting fluid 128 reaches a minimum pressure. This can prevent fluid from leaking out of nozzle 124 when there is not sufficient pressure for it to be shot up to undercut area 102. Alternatively an electronically actuated valve can be placed in each valve allowing, as described above, selective activation of only certain nozzles. In such an embodiment, at least 2 or 3 nozzles can be active at any given time to ensure machining surfaces are properly wetted and cooled before, during and after machining.

FIG. 3B depicts cutting fluid delivery nozzle 306, a slight variation on nozzle 124 depicted in FIG. 3A. Cutting fluid delivery nozzle 306 is oriented slightly off vertical and has a restricted spray pattern. In certain embodiments a benefit is achieved by angling cutting fluid delivery nozzle 306 at least slightly as depicted. For example, in FIG. 3B a slight setback of delivery channel 204 in the x-axis along with a slight rotation of cutting fluid delivery nozzle 306 can angle cutting fluid 128 more directly towards undercut area 102, thereby resulting in potential benefits to both cutting speed and cut quality. In machining operations where cutting tool 140 is spinning at high speeds cutting fluid tends to be removed more quickly from undercut area 102. Consequently, continuous and targeted delivery of cutting fluid 128 can be necessary to compensate for increased amounts of cutting fluid removed due to high spinning rates of cutting tool 140. Another, possible refinement to cutting fluid delivery is through use of a shaped spray pattern. Cutting fluid delivery nozzle 306 has a directed spray pattern, influenced more directly towards undercut area 102. By restricting flow from cutting fluid delivery nozzle 306, an increased percentage of cutting fluid 128 can reach machining surface 102, thereby improving performance of cutting fluid delivery system 200.

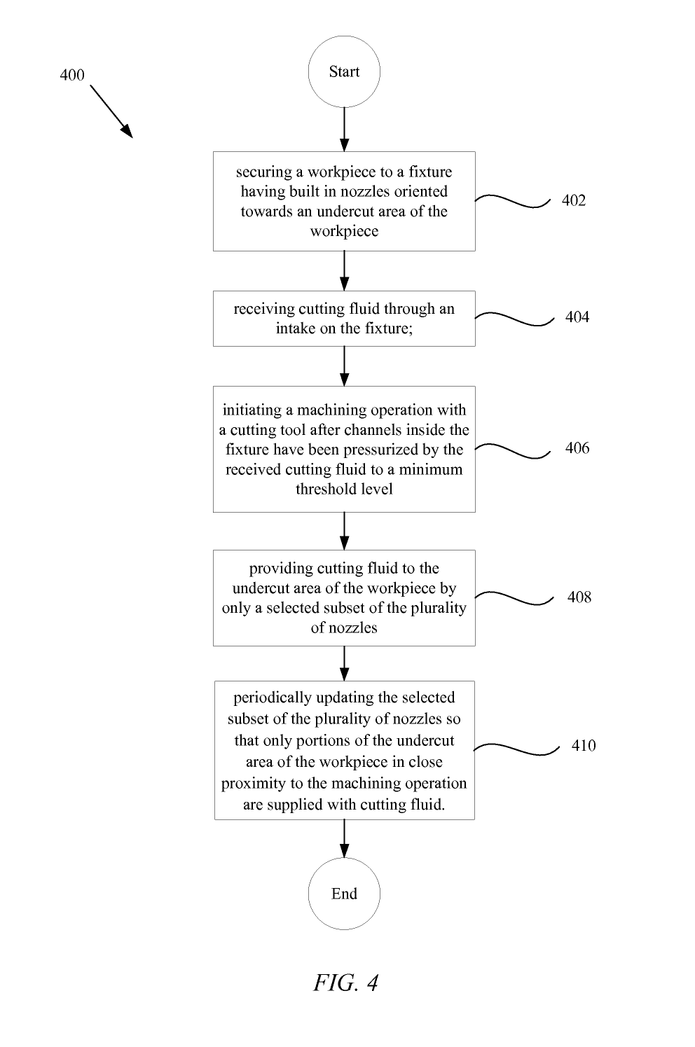

FIG. 4 shows a flow chart depicting process 400. In step 402 a workpiece is attached to a fixture having built in nozzles. The workpiece can be made of any material suited for machining. In one preferred embodiment the workpiece can be made of aluminum. The workpiece can be attached to the fixture by way of a vacuum attachment, removing any need for the workpiece to be bolted down or constrained in a way that would impair or obstruct machining operations. The fixture itself includes a number of cutting fluid delivery nozzles, oriented towards an undercut area of the workpiece. The cutting fluid delivery nozzles can be configured with a spray pattern specifically designed to target portions of the workpiece requiring machining. In this way unnecessary wetting of portions of the workpiece not requiring cutting fluid can be avoided. In step 404 cutting fluid is supplied to the fixture, allowing the cutting fluid delivery nozzles to be supplied with cutting fluid at a pressure calculated to supply sufficient amounts of cutting fluid to keep a cutting tool and the undercut area of the workpiece continuously covered in cutting fluid and properly cooled during a machining operation. To accomplish this pressurization a sealed series of channels inside the fixture can be configured to be pressurized with cutting fluid.

In step 406 a machining operation is initialized once cutting fluid in the fixture has reached a minimum pressure threshold. Such a determination can be made by the use of a pressure gauge located inside the fixture. Alternatively a ball valve can be arranged on the built in nozzles restricting flow until the minimum pressure is achieved. In step 408 cutting fluid is provided to the undercut area of the workpiece by a selected subset of nozzles. The subset of nozzles can be as few as 1 nozzle but generally will be at least two nozzles, depending on spray width and effectiveness of each of the nozzles. In some cases all the nozzles can be selected, when for example the entire workpiece needs to be cooled. The determination of which subset of nozzles should be selected can be based upon position of the cutting tool which in one embodiment is determined by sensors built into the fixture. Sensors capable of determining the cutting tool position include motion sensors and thermal sensors. In step 410 the selection of the subset of the plurality of nozzles is updated, based upon a changing current position of the cutting tool. Sensors built into the fixture can be used to track the position of the cutting tool. In some embodiments the sensors can also be used to determine flow rate of the cutting fluid based on factors such as cutting tool speed and temperature. It should be noted that the above process can be carried out by a Computer Numerical Control (CNC) system. The CNC system can be configured to maneuver the cutting tool and supply an appropriate amount of cutting fluid to the fixture. The CNC device can also direct the activation of certain cutting fluid delivery nozzles in accordance with the position of the cutting tool.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a computer readable medium for controlling manufacturing operations or as computer readable code on a computer readable medium for controlling a manufacturing line. The computer readable medium is any data storage device that can store data which can thereafter be read by a computer system. Examples of the computer readable medium include read-only memory, random-access memory, CD-ROMs, DVDs, magnetic tape, and optical data storage devices. The computer readable medium can also be distributed over network-coupled computer systems so that the computer readable code is stored and executed in a distributed fashion.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

What is claimed is:

1. A machining apparatus, comprising:
a workpiece attachment component configured to secure a workpiece during a machining operation, the workpiece attachment component comprising:
an intake configured to receive a continuous flow of cutting fluid, and
a plurality of nozzles each of which receives a corresponding portion of the continuous flow of cutting fluid, the plurality of nozzles configured to provide the cutting fluid to an undercut area of the workpiece otherwise obscured by a cutting tool in order to remove excess heat and provide additional lubrication during the machining operation,
wherein during the machining operation, only a subset of the plurality of nozzles corresponding to a current position of the cutting tool provides the cutting fluid to that portion of the workpiece undergoing the machining operation.

2. The machining apparatus as recited in claim 1, wherein the selected subset of the plurality of nozzles is all of the plurality of nozzles.

3. The machining apparatus as recited in claim 1, wherein the selected subset of the plurality of nozzles are determined based upon a current position of the cutting tool in relation to the workpiece.

4. The machining apparatus as recited in claim 3, wherein the selected subset of the plurality of nozzles is continuously updated in accordance with detected changes in the current position of the cutting tool.

5. The machining apparatus as recited in claim 4, wherein the cutting fluid is supplied at a flow rate sufficient to compensate for cutting fluid removed from the undercut area by a spinning cutting tool.

6. The machining apparatus as recited in claim 4, further comprising:
a thermal sensor configured to remotely detect a current temperature of the portion of the workpiece undergoing the machining operation, the thermal sensor providing a cutting tool location and a control signal used to set a flow rate of the cutting fluid based on the current detected temperature of the workpiece.

7. The machining apparatus as recited in claim 4, further comprising:
a motion sensor configured to detect a current position of the cutting tool with respect to the workpiece undergoing the machining operation, the motion sensor providing a control signal used to set a flow rate of the cutting fluid based at least in part upon measured velocity of the cutting tool.

8. A machining apparatus, comprising:
a fixture configured to secure a workpiece by vacuum suction during a machining operation, the fixture comprising:
a fluid intake configured to receive a continuous flow of cutting fluid,
a plurality of nozzles each of which receives a corresponding portion of the continuous flow of cutting fluid, the plurality of nozzles configured to provide the cutting fluid to an undercut area of the workpiece otherwise obscured by a cutting tool in order to remove excess heat and provide additional lubrication during the machining operation,
a manifold having a plurality of connecting channels configured to route cutting fluid from the fluid intake to the plurality of nozzles.
a plurality of sensors configured to remotely detect operating conditions during the machining operation,
wherein during the machining operation, only a subset of the plurality of nozzles corresponding to a current position of the cutting tool provides the cutting fluid to that portion of the workpiece undergoing the machining operation.

9. The machining apparatus as recited in claim 8, wherein the detected operating conditions include the position of the cutting tool during the machining operation and temperature conditions along the undercut area of the workpiece.

10. The machining apparatus as recited in claim 9, wherein the plurality of connecting channels each independently supply cutting fluid to a fixed number of the plurality of nozzles.

11. The machining apparatus as recited in claim 10, wherein the plurality of connecting channels are configured with valves that can be opened and closed to activate and deactivate selected subsets of the plurality of nozzles.

12. The machining apparatus as recited in claim 10, wherein the plurality of nozzles only emit cutting fluid when the cutting fluid reaches a minimum pressure threshold.

13. A machining method, comprising:
securing a workpiece to a fixture having a plurality of integrated nozzles oriented towards an undercut area of the workpiece;
receiving cutting fluid through an intake on the fixture;
initiating a machining operation with a cutting tool after channels inside the fixture have been pressurized by the received cutting fluid to a minimum threshold level;
providing cutting fluid to an undercut area of the workpiece by only a selected subset of the plurality of nozzles; and
periodically updating the selected subset of the plurality of integrated nozzles so that only portions of the undercut area of the workpiece in close proximity to the machining operation are supplied with cutting fluid.

14. The machining method as recited in claim 13, wherein the current position of the cutting tool is tracked by at least one sensor integrated into the fixture.

15. The machining method as recited in claim 14, wherein the integrated sensor is a motion sensor configured to detect movement of the cutting tool and based on that detected motion determine an appropriate flow rate for the selected subset of the plurality of nozzles to emit.

16. The machining method as recited in claim 14, wherein the integrated sensor is a thermal sensor configured to detect a current temperature of the portion of the undercut area of the workpiece undergoing the machining operation, the thermal sensor providing a control signal used to set a flow rate of the cutting fluid to appropriately manage the detected current temperature of the workpiece.

17. The machining method as recited in claim 14, wherein the periodicity of the updating is determined by an average speed of the cutting tool.

18. The machining method as recited in claim 17, wherein subsets of the plurality of nozzles are activated and deactivated by actuating valves associated with each of the plurality of nozzles.

19. The machining method as recited in claim 18, wherein each of the plurality of nozzles is oriented directly towards the undercut area of the workpiece and shaped in a spray pattern to minimize wetting of areas that do not come into contact with the cutting tool.

20. The machining method as recited in claim 14, wherein there are a plurality of integrated sensors including both motion sensors and thermal sensors for accurately determining position and temperature information of the cutting tool during the machining operation.
